(19) United States
(12) Patent Application Publication
(10) Pub. No.: US 2004/0213712 A1
(43) Pub. Date: Oct. 28, 2004

(54) Gas generation system having a reformer and a device for the selective separation of hydrogen from the reformate gas stream

(75) Inventors: Thomas Beckmann, Stuttgart (DE); Christian Duelk, Dornstadt (DE); Arnold Lamm, Elchingen (DE); Thomas Poschmann, Ulm (DE); Jochen Schaefer, Ulm (DE)

Correspondence Address: DAVIDSON, DAVIDSON & KAPPEL, LLC, 485 SEVENTH AVENUE, 14TH FLOOR, NEW YORK, NY, 10018, US

(73) Assignee: DaimlerChrysler AG, Stuttgart (DE)

(21) Appl. No.: 10/820,188

(22) Filed: Apr. 7, 2004

(30) Foreign Application Priority Data
Apr. 7, 2003 (DE) DE 103 15 698.4

(51) Int. Cl. B01J 8/00; H01M 8/06

(52) U.S. Cl. 422/234; 429/19; 422/187

(57) ABSTRACT

A gas generation system includes a reformer for producing a hydrogen-containing reformate gas using raw materials, at least a first of the raw materials containing carbon and hydrogen, a separator device configured to selectively separate the hydrogen-containing reformate gas into hydrogen and a residual gas, and a recirculation system. The recirculation system recirculates an amount of the residual gas from a first location downstream of the separator device to a second location upstream from the separator device. The gas generation system may be used to produce a hydrogen-containing gas from liquid hydrocarbons, such as gasoline or diesel oil, for operating a fuel cell. The fuel cell may be part of a drive device or of an auxiliary power unit, in particular in a motor vehicle.

Priority is claimed to German Patent Application No. DE 103 15 698.4 that was filed on Apr. 7, 2003, the entire disclosure of which is incorporated by reference herein.

The present invention relates to a gas generation system having at least one reformer for generating a hydrogen-containing reformate gas stream from raw materials, at least one of which contains carbon and hydrogen, and having at least one device for the selective separation of hydrogen from the hydrogen-containing reformate. The present invention also relates to an application for such a gas generation system.

### BACKGROUND

Fuel cells, in particular those for mobile applications, may be supplied with hydrogen by gas generation devices, for example by reforming hydrocarbons or hydrocarbon derivatives, such as methanol, gasoline or diesel oil. The reformate gas that is produced in a reforming process contains hydrogen, as well as carbon monoxide, carbon dioxide and water vapor. The carbon monoxide, in particular, must be removed for use in the fuel cell, since this gas acts as a catalyst toxin and results in performance losses in the fuel cell.

Diaphragms, which may be made of various materials, such as ceramic, glass, polymer or metal, have long been used for the selective separation of hydrogen. Metal diaphragms are characterized by high selectivity for hydrogen and high temperature stability, but have relatively low permeation rates.

To achieve a desired permeation rate, a large number of diaphragm cells are used, each having a hydrogen-selective diaphragm, where the reformate gas flows against the individual diaphragms either one after the other (serially) or side-by-side (in parallel). The diaphragm cells are stacked on top of each other to form a compact hydrogen separation module.

Hydrogen separation modules or diaphragm modules of this type are described for example in DE 198 60 253 C1 or DE 199 20 517 C1.

With regard to the general related art, a method for generating hydrogen is described in DE 199 34 649 A1. In this instance, a hydrocarbon-containing mixture is fed to a reformer, and the generated hydrogen is preferably sent to a fuel cell to generate electricity. To reduce the formation of soot in the reformer and to increase the yield of hydrogen and the efficiency of the overall system, the cited document proposes that at least part of the gas produced by the reformer be recirculated and fed again to the reformer before and/or after being conveyed to the fuel cell.

### SUMMARY OF THE INVENTION

An object of the present invention is to increase the hydrogen yield of the gas generation system having at least one reformer for generating a hydrogen-containing reformate gas stream from raw materials, at least one of which contains carbon and hydrogen, and having at least one device for the selective separation of hydrogen from the hydrogen-containing reformate, while using as little energy as possible.

The present invention provides a gas generation system having at least one reformer for producing a hydrogen-containing reformate gas stream from raw materials, at least one of which contains carbon and hydrogen, and also having at least one device for the selective separation of hydrogen from the hydrogen-containing reformate, wherein a recirculation system (7a, 7b, 7c) is provided via which at least part of the residual gas that remains after the device (5) for the selective separation of hydrogen is recirculated to the area in front of the device (5) for the selective separation of hydrogen.

According to the present invention, part of the residual gas, the retentate, which includes the contents that are present along with the hydrogen in the reformate gas stream, such as water vapor, carbon monoxide, raw material remnants and a proportion of residual hydrogen remaining in the retentate, is recirculated into the area of the gas generation system. This enables the retentate contents to be supplied once again to the conversion process in the gas generation system, thereby ultimately increasing its hydrogen yield.

It is particularly advantageous that the water vapor recirculated with the retentate is already present in vapor form, and that the energy to vaporize water that would need to be supplied externally in its stead may be saved.

Another advantage of the recirculation is the fact that at least part of the hydrogen remaining in the retentate is fed to the gas generation system again, and not burned, as is customary in systems according to the known methods. As a result, the total present hydrogen is utilized in a significantly improved manner, so that an increase in the efficiency of such a system is ultimately also possible.

A particularly advantageous embodiment of the idea according to the present invention provides for at least part of the residual gas to be recirculated to directly in front of the device for the selective separation of hydrogen.

In this design of the recirculation system according to the present invention, residual hydrogen is contained in the retentate. The recirculation to a location directly in front of the device for the selective separation of hydrogen results in a sort of “separation reactor.” The recirculated residual hydrogen is fed time and again through the separation process, so that the hydrogen content of the reformate gas flowing into the device increases. The thus increased molar flow of hydrogen increases the hydrogen yield in the usual devices for the selective separation of hydrogen, for example using diaphragms that are selectively permeable for hydrogen.

In addition to the one device described here, it would also be possible to provide a plurality of the devices, for example when using selective diaphragms in a cascaded configuration with respect to hydrogen content and diaphragm surface.

According to a particularly favorable refinement of the structure of the present invention, this is designed in such a way that at least part of the residual gas is recirculated by the recirculation system to the area where the raw materials enter the reformer.

In contrast to the embodiment just described, because of the subsequently explained steam-to-carbon ratio, the main interest of this embodiment is the recirculated water vapor. The small proportion of residual hydrogen represents an advantage, since in contrast to the direct recirculation of reformate according to the related art, it is consequently possible to prevent the reaction in the reformer from being impeded by a shift in the equilibrium of the reaction due to the significantly higher concentration of hydrogen in the educts.

Because of these reciprocally utilized properties of the recirculated part of the retentate, the combination of these two embodiments, in particular, is advantageous, i.e., with recirculation of part of the retentate to in front of the single-stage or multiple-stage reformer, as well as with recirculation of part of the retentate to in front of the device for the selective separation of hydrogen.

A particularly advantageous design of the gas generation system according to the present invention provides for at least part of the residual gas to be fed by the recirculation system to an area between the reformer and a device for enriching the hydrogen-containing gas stream with hydrogen, which is positioned between the reformer and the device for the selective separation of hydrogen.

This particularly advantageous design makes it possible to in turn direct the residual components remaining in the residual gas or retentate left over from the selective separation of hydrogen at their relatively high temperature level to an appropriate device to be enriched with hydrogen. This device may be, for example, a shift stage, in particular a high temperature shift stage.

A known shift according to the hydrogen shift reaction may be used to obtain additional hydrogen from the components remaining in the residual gas that is then fed back to the device for the selective separation of hydrogen. The higher supply and higher concentration of hydrogen allows separation in larger proportions than without recirculation.

The design also has energy advantages compared to recirculation to the reformer area, since this would require the recirculated gas stream to be appropriately reheated to the temperatures prevailing in the reformer, whereas the temperatures in the area of the device for enriching the hydrogen-containing gas stream with hydrogen and of the device for the selective separation of hydrogen are far less different than the temperatures between the devices for the selective separation of hydrogen and the reformer.

Here too, it would of course again be conceivable to use a combination of the individual described versions of retentate recirculation, or of all of them together.

In particular in the last two described designs of the gas generation system according to the present invention, the ratio of the quantity of water vapor to hydrocarbon is to be noted. As the proportion of water vapor to hydrocarbon increases, the hydrogen yield of the gas generation system rises in a particularly advantageous manner. In addition, correspondingly high proportions of water vapor to hydrocarbon have a positive effect on the life of catalysts, since excessively low proportions of water vapor to hydrocarbon are generally seen as a major cause of aging of catalysts.

In both steam reformers and autothermal reformers, the primary raw material besides the hydrogen-containing base material is the large quantity of water vapor needed in comparison to the base material. For use in the reformer, this water must be appropriately heated, vaporized and overheated, which requires a corresponding heat output because of the high thermal capacity of water. If the proportion of water vapor to hydrocarbon is increased appropriately in order to obtain the advantages named above, the amount of water needed increases at the same time. This then produces a negative effect, such as the need for an extremely high heat output.

At the same time, the water utilized in such gas generation systems is recovered. This is generally accomplished by condensing out the water vapor, so that the required cooling capacity is also correspondingly high in this instance. To achieve a high yield of hydrogen and long life of the employed catalysts with an appropriately low heating and cooling output, it is particularly advantageous to recirculate the retentate again in one of the manners indicated above, since the retentate normally already contains water as steam, so that an increase in the addition of hydrogen-containing base material during recirculation allows a correspondingly favorable and advantageous ratio of steam to hydrocarbon to be set, the quantity of water supplied externally for that purpose, which would have to be vaporized and overheated, being minimal to infinitesimal.

Thus, the configuration according to the present invention makes it possible through recirculation to utilize the corresponding benefits of a high proportion of water vapor to hydrocarbon with a low heating and cooling output.

In a particularly favorable further refinement, the gas generation system according to the present invention provides for the recirculation system to have a transport device for the recirculated residual gas.

Such a transport device compensates for the pressure losses in the individual components, so that recirculation may be realized simply and without influencing the pressure conditions in the components themselves, according to one or more of the embodiments named above.

An advantageous further refinement of this provides for the transport device to be designed as a gas jet pump, which is driven by the volume flow of at least one of the raw materials or the hydrogen-containing gas stream.

The use of a gas jet pump or jet pump for the recirculated part of the retentate allows a means of transport in the nature of a compressor or the like to be dispensed with. Instead, the kinetic energy content of the educt or reformate gas stream flowing to the reformer, the device for enriching the hydrogen-containing gas stream with hydrogen, and/or the device for the selective separation of hydrogen, is adequate to transport the recirculated retentate.

In addition to compensating for the pressure loss in the recirculated part of the retentate, the gas jet pump has the decisive advantage that the pressure loss may be compensated for without moving parts as a function of the design. As a result, appropriately high temperatures and/or aggressive substances in the retentate are not harmful to the long-term functional reliability of the design.

A particularly favorable use of such gas generation systems is for generating a hydrogen-containing gas from liquid hydrocarbons and/or other hydrocarbon derivatives.

Since the designs according to the present invention ultimately make it possible to minimize the energy required to produce hydrogen and to increase the hydrogen yield, use in particular for operating a fuel cell is advantageous, and in this case in particular for operating a fuel cell on the basis of commercially customary hydrocarbon- and hydrogen-containing base materials, such as gasoline, diesel oil, or corresponding hydrocarbon derivatives, such as methanol or the like.

The fuel cell may in turn be utilized in various types of fuel cell systems, it being advantageous, because of the particularly high energy yield and the favorable efficiency, to use it in a fuel cell system that is employed in an air, land or water vehicle, since the ratio of energy efficiency and range to the fuel on board is of particular importance in this instance. The fuel cell may either be part of a drive system or part of an auxiliary power unit (APU), as it is employable in such systems.

### BRIEF DESCRIPTION OF THE DRAWINGS

The present invention is described below on the basis of exemplary embodiments and with reference to the drawings, in which:

FIG. 1 shows a first possible embodiment of the gas generation system according to the present invention;

FIG. 2 shows a second possible embodiment of the gas generation system according to the present invention; and

FIG. 3 shows a third possible embodiment of the gas generation system according to the present invention.

### DETAILED DESCRIPTION

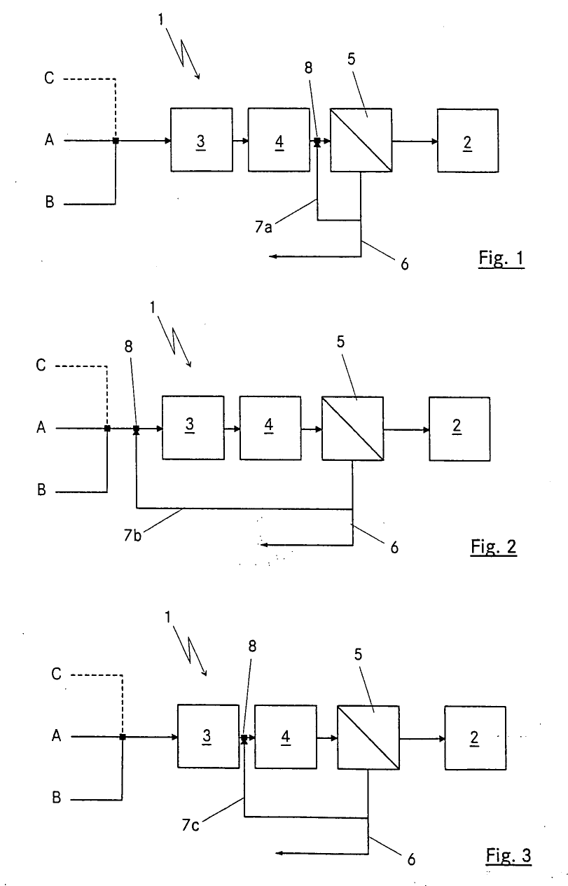

FIG. 1 shows a gas generation system 1 via which a fuel cell 2 is supplied with hydrogen. In gas generation system 1, a hydrogen-containing gas is produced from suitable raw materials in a manner known per se. In the exemplary embodiment according to the figures present here, this is to occur via a reformer 3 and an optional device for increasing the hydrogen content, for example a single-stage or multiple-stage shift device 4, as well as a device 5 for separating hydrogen from the hydrogen-containing reformate gas stream.

The appropriate raw materials A, B and C are fed to reformer 3, which may be configured, for example, as a steam reformer or an autothermal reformer. These raw materials may be in particular a hydrocarbon-containing base material, such as gasoline, diesel oil, or possibly also methanol or the like. In addition to this raw material designated in the figures as A, water or water vapor—which is identified as B in the subsequent figures—is fed to reformer 3. Along with these two raw materials, an oxygen-containing medium, such as air, which is identified in the figures as C, may optionally be supplied as an additional educt.

From these raw materials or educts, a hydrogen-containing reformate is produced in the reformer in a manner known per se, its hydrogen concentration then being increased again by the already mentioned optional single-stage or multiple-stage shift device 4. The hydrogen-containing reformate then travels to device 5 for the separation of the hydrogen-containing gas from the hydrogen-containing reformate. This device 5 may be designed, for example, as a diaphragm module 5, in which a large part of the hydrogen contained in the reformate gas stream is separated by diaphragms that are selectively permeable for hydrogen and is sent to fuel cell 2.

The residual gas stream, known as the retentate, travels through line 6 out of the area of diaphragm module 5, and may be fed in a manner know per se for example to a combustion process or the like. In gas generation system 1 shown here, a recirculation line 7a additionally branches off from this retentate line 6 and conducts at least part of the retentate into the area of a junction 8, which is designed in such a way that, in its vicinity, the retentate returned via recirculation line 7a is again fed to the hydrogen-containing reformate gas stream.

Junction 8 may also be in the form of a gas jet pump, in order to compensate for the pressure loss produced in the case of FIG. 1 in the area of diaphragm module 5, so that the at least partially recirculated retentate is fed to the hydrogen-containing reformate gas stream, which drives the gas jet pump.

The recirculated part of the retentate may be predetermined for example by the transport capacity of the gas jet pump or the diameter of retentate line 6 and recirculation line 7a, but proportional valves in the area where recirculation line 7a branches off from retentate line 6 are also conceivable.

In the embodiment shown in FIG. 1, the recirculated part of the retentate is introduced into the hydrogen-containing reformate gas stream directly in front of diaphragm module 5. The intended effect is to produce a sort of “diaphragm reactor,” in which the residual hydrogen still present in the retentate is used to increase the hydrogen concentration in diaphragm module 5 and thus to improve the separation of the hydrogen in diaphragm module 5. As a result, the hydrogen yield is thus able to be increased via diaphragm module 5 in the design shown here.

FIG. 2 shows a design that is largely comparable to the design described above. Only recirculation line 7b, which is shown in FIG. 2, does not lead from the area of retentate line 6 to directly in front of diaphragm module 5, but from the area of retentate line 6 to directly in front of reformer 3. Also in this case, junction 8 may be in the form of a gas jet pump that is driven according to the exemplary embodiment illustrated here by the mixture of educts A, B, C flowing toward reformer 3. In addition to this mixture, the gas jet pump could of course also be designed in such a way that it would be driven by only one of the educts.

In contrast to the recirculation of the retentates according to FIG. 1, the emphasis of the recirculation in the embodiment according to FIG. 2 is on having the retentate and the water contained in it recirculated through recirculation line 7b into the area of reformer 3. Since the water is present in the form of steam, it is possible to reduce the necessary addition of the educt water or steam, so that the thermal energy necessary to vaporize the saved water may also be saved.

FIG. 3 shows another embodiment of gas generation system 1, the single-stage or multiple-stage shift device 4 being no longer optional but being absolutely necessary in this embodiment according to FIG. 3. Recirculation of at least part of the retentate through recirculation line 7c according to FIG. 3 now takes place precisely in this area between shift device 4 and reformer 3. Here too, junction 8 may again be in the form of a gas jet pump that is driven by the reformate gas stream flowing from reformer 3 to shift device 4.

The advantage of such a design of gas generation system 1 is that the temperature levels of diaphragm module 5 and of shift stage 4 are relatively similar, so that heating of the recirculated retentate can largely be dispensed with or takes place automatically as a result of the energy content in the reformate gas stream. Energy is again consequently saved, and in addition, the reformate gas stream is cooled by the recirculated retentate to the extent that it may be converted under the ideal temperature conditions in single-stage or multiple-stage shift device 4.

The forms of retentate recirculation in gas generation system 1 illustrated in the three figures described above are usable both individually, as illustrated in principle here, and in every conceivable combination with each other. For example, part of the retentate may be returned to the area of diaphragm module 5, another part to the area of reformer 3, and possibly a third part to the area of shift device 4. A remaining portion may still be directed through retentate line 6 for another purpose, such as catalytic combustion to vaporize the water that is still needed externally.

What is claimed is:

1. A gas generation system, comprising:
a reformer for producing a hydrogen-containing reformate gas using raw materials, at least a first of the raw materials containing carbon and hydrogen;
a separator device configured to selectively separate the hydrogen-containing reformate gas into hydrogen and a residual gas;
a recirculation system for recirculating an amount of the residual gas from a first location downstream of the separator device to a second location upstream from the separator device.

2. The gas generation system as recited in claim 1, wherein the second location is directly in front of the separator device.

3. The gas generation system as recited in claim 1, wherein the second location is in an entry area where the raw materials enter the reformer.

4. The gas generation system as recited in claim 1, further comprising an enrichment device configured to enrich the hydrogen-containing reformate gas with hydrogen and disposed between the reformer and the separator device, wherein the second location is between the reformer and the enrichment device.

5. The gas generation system as recited in claim 1, wherein the separator device includes at least one diaphragm selectively permeable for hydrogen.

6. The gas generation system as recited in claim 1, wherein the recirculation system includes a transport device for the recirculated residual gas.

7. The gas generation system as recited in claim 6, wherein the transport device includes a gas jet pump driven by a volume flow of at least one of the raw materials or the hydrogen-containing reformate gas stream.

8. The gas generation system as recited in claim 1, wherein the reformer includes a steam reformer.

9. The gas generation system as recited in claim 1, wherein the reformer includes an autothermal reformer.

10. The gas generation system as recited in claim 1, wherein the gas generation system is configured to generate a hydrogen-containing gas from one of a liquid hydrocarbons and hydrocarbon derivatives for operating a fuel cell.

11. The gas generation system as recited in claim 10, wherein the gas generation system is configured to generate a hydrogen-containing gas from one of a gasoline and a diesel oil.

12. The gas generation system as recited in claim 10, wherein the fuel cell is part of a drive system for one of a water transportation device, a land transportation device, and an air transportation device.

13. The gas generation system as recited in claim 10, wherein the fuel cell is part of an auxiliary power unit.

14. The gas generation system as recited in claim 13, wherein, the auxiliary power unit is utilized in a transportation device, the transportation device including at least one of a water transportation device, a land transportation device, and an air transportation device.

15. The gas generation system as recited in claim 14, wherein the transportation device is driven by an internal combustion engine.

16. The gas generation system as recited in claim 1, wherein the residual gas includes hydrogen.
